(19) United States
(12) Patent Application Publication
(10) Pub. No.: US 2025/0376140 A1
(43) Pub. Date: Dec. 11, 2025

(54) APPARATUS FOR DRUM BRAKE ASSEMBLY

(71) Applicants: ZF Active Safety US Inc., Livonia, MI (US); ZF Friedrichshafen AG, Friedrichshafen (DE); ZF Active Safety GmbH, Koblenz (DE); ZF Automotive Brasil Ltda., Limeira (BR)

(72) Inventors: Thomas Schwegler, Tettnang (DE); Detlef Baasch, Oberteuringen (DE); Andreas Knoll, Lindau (DE); Marc Schieß, Hohenfels (DE); Martin Ruider, Schwarzhofen (DE); Ingo Decker, Friedrichshafen (DE); Galus Chelaidite, South Lyon, MI (US); Lukas Madzgalla, Lahnstein (DE); Rui Bertim de Campos, Limeira (BR); Michael Pantke, Friedrichshafen (DE); Nico Rueß, Meckenbeuren (DE); Tobias Stanger, Attenweiler (DE); Michael Huber, Langenargen (DE)

(21) Appl. No.: 18/739,670

(22) Filed: Jun. 11, 2024

(51) Int. Cl. B60T 13/74; B60T 17/22; F16D 63/00; F16D 65/22; F16D 65/56; F16D 66/00; F16D 121/20; F16D 121/24; F16D 125/40; F16D 127/02; F16D 127/06

(52) U.S. Cl. CPC B60T 13/746; B60T 17/22; F16D 63/006; F16D 65/22; F16D 65/561; F16D 66/00; F16D 2066/003; F16D 2066/006; F16D 2121/20; F16D 2121/24; F16D 2125/40; F16D 2127/02; F16D 2127/06

(57) ABSTRACT

An apparatus for a brake drum of a vehicle having a drum brake assembly with first and second brake shoes includes a motor with a pinion gear. A ball screw assembly has a nut for receiving torque from the pinion gear and a spindle threaded with the nut. The nut is aligned with the first brake shoe and the spindle is aligned with the second brake shoe. The motor is actuatable for rotating the nut to move the nut and the spindle away from one another for moving the brake shoes to apply braking force to the brake drum during a braking event. A bi-stable locking mechanism selectively locks the motor to prevent torque transfer from a back-driving ball screw assembly to the motor.

### TECHNICAL FIELD

The present invention relates generally to braking systems, and specifically to a brake pad actuator for a drum brake assembly.

### BACKGROUND

Drum brakes are typically provided on the rear wheels of vehicles in order to braking to the vehicle wheels. The brakes include brake shoes selectively movable away from one another and into engagement with the brake drum to apply braking force to the brake drum via the friction material bonded to each brake shoe. The brake shoes are locked in this position to apply and hold the brake until released by the vehicle operator.

### SUMMARY

In one aspect of the invention, an apparatus for a brake drum having a drum brake assembly with first and second brake shoes includes a motor with a pinion gear. A ball screw assembly has a nut for receiving torque from the pinion gear and a spindle threaded with the nut. The nut is aligned with the first brake shoe and the spindle is aligned with the second brake shoe. The motor is actuatable for rotating the nut to move the nut and the spindle away from one another for moving the brake shoes to apply braking force to the brake drum during a braking event. A bi-stable locking mechanism selectively locks the motor to prevent torque transfer from a back-driving ball screw assembly to the motor.

In another aspect, a method of operating a brake drum having a drum brake assembly with first and second brake shoes includes positioning a ball screw assembly having a starting length between the first and second brake shoes for moving the first and second brake shoes to apply braking force to the brake drum during a braking event. A motor is coupled to the ball screw assembly for adjusting the length thereof. A bi-stable locking mechanism is activated to prevent rotation of the motor and thereby prevent back-drive of the ball screw assembly for adjusting the starting length of the ball screw assembly prior to each braking event to account for wear on the brake shoes.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a drum brake assembly in accordance with an aspect of the present invention.

FIG. 2 is a schematic illustration of a brake drum of the drum brake assembly.

FIG. 3 is a schematic illustration of an example brake shoe actuator prior to performing a braking event.

FIG. 4 is an enlarged view of a portion of FIG. 3.

FIG. 5 is a schematic illustration of the shoe actuator when a service brake operation is performed.

FIG. 6 is a schematic illustration of the shoe actuator applying a parking brake.

FIG. 7 is a schematic illustration of the shoe actuator having different conditions in response to wear on the brake shoes.

### DETAILED DESCRIPTION

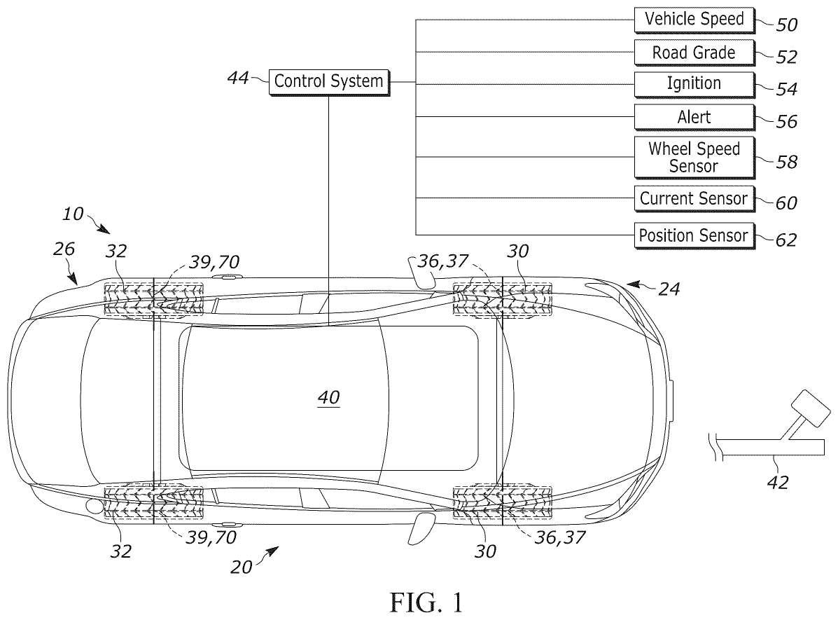

The present invention relates generally to service brake systems, and specifically to a brake shoe actuation device for a drum brake assembly. FIG. 1 illustrates an example electric brake/braking system 10 for a motor vehicle 20 in accordance with the present invention.

The vehicle 20 extends from a first or front end 24 to a second or rear end 26. A pair of steerable wheels 30 is provided at the front end 24. Each wheel 30 includes a wheel drum 36 driven and steered by a steering linkage (not shown). Disc brakes 37 are associated with each wheel drum 36. A brake pedal 42 can be used to actuate the disc brakes 37 to apply service braking to the wheels 30.

A pair of steerable or non-steerable wheels 32 is provided at the rear end 26. Each rear wheel 32 includes a brake drum (not shown) driven by a steering linkage (not shown). Service brake electromechanical drum assemblies 39, henceforth referred to as “eDrum” or drum brake assemblies, are associated with each brake drum. A propulsion system 40, e.g., an engine and/or battery, supplies torque to the wheels 30.

A control system 44 is provided to help control operation of the vehicle 20, such as operation of the propulsion system 40 and vehicle braking, including operation of the parking brake function of the eDrum 39. To this end, the control system 44 can include one or more controllers, such as a propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of ignition status. A wheel speed sensor 58 is provided on/adjacent to each wheel 32 and generates signals indicative of the speed at each wheel. The control system 44 also receives signals indicative of the degree-including velocity and acceleration-the brake pedal 42 is depressed.

The control system 44 can receive and interpret these signals and perform vehicle functions, e.g., braking, in response thereto. In one example, the control system 44 can detect wheel slip between one or more wheels 30, 32 and the driving surface based on the sensors 50, 58 and perform anti-lock braking (ABS) and/or electronic stability control (ESC) using one or more disc and/or drum brakes 37. The control system 44 can also be connected to an alert 56 for notifying the driver/operator of the vehicle 20 of vehicle conditions, vehicle status, braking events, and/or environmental conditions.

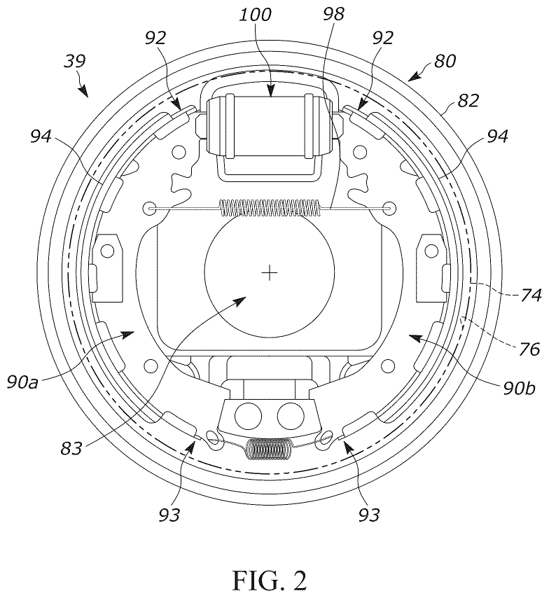

Referring to FIG. 2, the eDrum 39 includes an adapter or backplate assembly 80. The adapter assembly 80 includes a central adapter or backplate 82 having a central opening 83. A pair of brake shoes 90a, 90b is mounted to the back plate 82 on opposite sides of the opening 83 and within the same plane as one another. Each brake shoe 90a, 90b extends from a first end 92 (upper as shown) to a second end 93 (lower as shown). The eDrum 39 is positioned within a brake drum 74 having an inner surface 76 (both illustrated in phantom in FIG. 2) confronting the brake shoes 90a, 90b.

Friction material 94 is secured or bonded to each brake shoes 90a, 90b and has the same shape and general contour as the inner surface 76 of the brake drum 74. A tension spring 98 is connected to each brake shoe 90a, 90b for biasing the brake shoes towards one another.

The brake shoes 90a, 90b are selectively operable between braking and non-braking positions. In the braking position, the brake shoes 90a, 90b contact and press against the inner surface 76 of the brake drum 74 to slow or otherwise stop rotation of the rear wheel 32 (FIG. 1) to which the brake drum is rotationally fixed. In the non-braking position, the brake shoes 90a, 90b do not contact the inner surface 76 of the brake drum 74 and thereby allow the rear wheel 32 to rotate freely.

An actuator 100 is secured to the backplate assembly 80 and positioned generally between the ends 92 of the brake shoes 90a, 90b. The actuator 100 is responsible for displacing the ends for selectively applying the service brake and/or parking brake, as will be discussed.

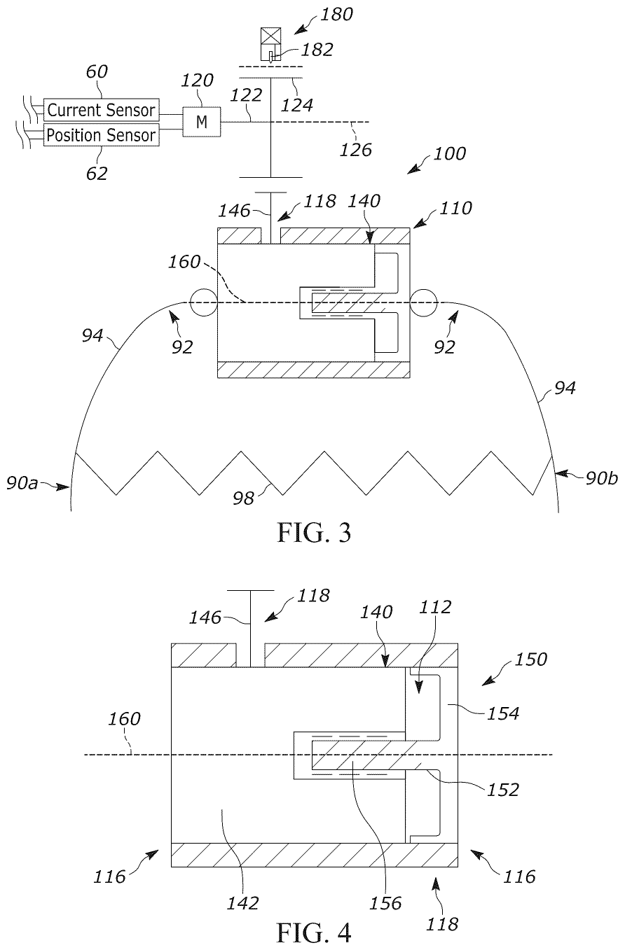

As shown in FIG. 3, the actuator 100 includes a tubular guide 110 fixed to the vehicle 20, e.g., fixed to the backplate assembly 80, and defining an interior space 112. A pair of openings 116 extends through opposite ends of the guide 110 to the interior space 112. Another opening 118 extends radially through the guide 110. The actuator 100 further includes a motor 120 having a shaft 122. A motor pinion or pinion gear 124, such as a spur gear, is rotatable with the shaft 122 about an axis 126. A current sensor 60 and rotational position sensor 62 are connected to the motor 120 and to the control system 44 for sending/receiving signals indicative of the motor operation.

The pinion gear 124 is meshed a ball screw assembly 140 provided within the guide 110. An example ball screw assembly is shown and described in U.S. patent application Ser. No. 16/157,027, filed Oct. 10, 2018, the entirety of which is incorporated herein by reference. In this particular example, a single ball screw assembly 140 is provided in the interior space 112. It will be appreciated, however, that multiple ball screw assemblies could be longitudinally aligned with one another within the interior space (not shown).

Referring to FIG. 4, the ball screw assembly 140 includes a nut 142 including or integrally formed with a gear 146 for receiving torque from the pinion gear 124 on the motor 120. In one example, the gear 146 extends radially through the opening 118 in the guide 110 and into meshed engagement with the pinion gear 124. Alternatively, one or more gears (not shown) can be provided between pinion gear 124 and the gear 146 for transferring torque therebetween. At the same time, the nut 142 is axially aligned with and initially spaced from the end 92 of the brake shoe 90a.

The ball screw assembly 140 further includes a spindle 150 having a head 154 and aa shaft 152 extending from the head. The shaft 152 extends into the nut 142 and has a threaded connection 156 therewith. The head 154 is aligned with and initially spaced from the end 92 of the brake shoe 90b. It will be appreciated that the nut 142 and spindle 150 are not self-locking with one another. Furthermore, the head 154 of the spindle 150 is keyed with the guide 110 or otherwise configured to prevent rotation of the spindle.

Returning to FIG. 3, a locking mechanism 180, such as a bi-stable locking mechanism, is provided adjacent to the motor pinion 124 for selectively preventing torque transfer from a back-driving ball screw assembly 140 to the motor 120. The bi-stable locking mechanism 180 can include a bi-stable solenoid or electromagnet having a positive voltage polarity position and a negative voltage polarity position. In particular, the bi-stable locking mechanism 180 includes a projection or pawl 182 having a first, retracted position spaced from the pinion gear 124 and allowing for rotation thereof. The projection 182 also has a second, extended position engaged with the pinion gear 124 for preventing rotation thereof.

It will be appreciated that the locking mechanism 180 could instead be positioned adjacent any gear in the gear train between the pinion gear 124 and the gear 146 or adjacent the gear 146 itself. In this scenario, the projection 182 has the first and second position relative to the gear train or the gear 146. Regardless, moving the projection 182 to the second position locks the pinion gear 124 by either directly or indirectly preventing rotation thereof.

The projection or pawl 182 can move between the first and second positions by moving axially, rotating and/or pivoting. The control system 44 can be connected to and control operation of the bi-stable locking mechanism 180 by controlling the electrical power supplied thereto. That said, the bi-stable locking mechanism 180 does not require a constant voltage application to maintain any one position.

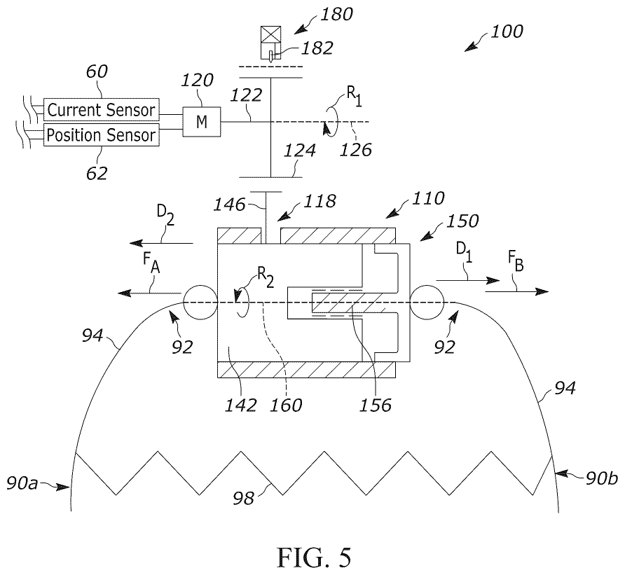

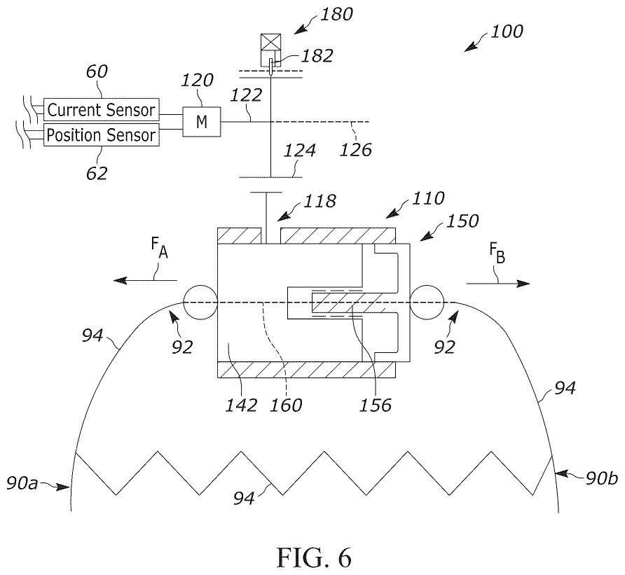

Operation of the brakes is illustrated in FIGS. 5-6. During operation of the vehicle 20, the driver depresses the brake pedal 42 (see also FIG. 1) to operate the disc brake assemblies 39 and apply electromechanical service braking to one or more wheels 30, 32. This will decelerate a moving vehicle, bringing it to a stop such that the vehicle 20 remains stationary on a hill (uphill or downhill). In any case, while the brake pedal 42 remains depressed and the vehicle is stationary, the driver can then apply the parking brake, e.g., electronically, by pushing a button, in which case the locking mechanism 180 engages the motor pinion gear 124 via the pawl 182. Once the pinion gear 124 is engaged by the pawl 182, electrical power to the motor 120 and to the locking mechanism 180 can be turned off, since the vehicle is successfully parked.

To apply the service brake while the vehicle 20 is moving, i.e., while the brakes are initially fully retracted, the control system 44 must first disengage the bi-stable locking mechanism 180 while at the same time electrically powering the motor 120 but maintain it stationary. Once the control system 44 confirms the bi-stable locking mechanism 180 is disengaged, the motor 120 is then commanded to rotate in a direction as to apply the brake shoes 90a and 90b against the brake drum 74, thus slowing down the moving vehicle 20.

The control system 44 receives signals from one or more of the sensors, e.g., the brake pedal sensor, vehicle speed sensor 50, road grade sensor 52 and/or wheel speed sensor 58, and determines the level of appropriate service braking and whether the parking brake also needs to be applied. Regardless, the control system 44 first actuates the actuator 100 associated with cach rear wheel 32.

To this end, and referring to FIG. 5, the control system 44 actuates the motor 120 to rotate the pinion gear 124 about the axis 126 in the manner R₁ (clockwise as shown). This rotates the nut 142 about the axis 160 in the manner R₂ (counterclockwise as shown). Due to the threaded connection 156, rotation of the nut 142 in the manner R₂ causes the spindle 150 to advance longitudinally away from and relative to the nut in the direction D₁ and out of the opening 116.

The head 154 of the spindle 150 ultimately moves into engagement with the end 92 of the brake shoe 90b. The brake shoes 90a, 90b are initially spaced from the inner surface 76 of the brake drum 74, and, thus, there is little to no initial resistance to outward movement of the brake shoes towards the inner surface 76. Consequently, the brake shoe 90b pivots outward until the friction pad 94 engages the inner surface 76 of the brake drum 74 to apply a braking force F_{B} thereto. This, in turn, imparts a reaction force upon the spindle 150, thereby preventing further movement of the spindle along the axis 160.

That said, further rotation of the nut 142 in the manner R₂ causes the nut to move away from the spindle 150 in the direction D₂. This translation is accommodated by the radial opening 118 in the guide 110. In other words, the gear 146 moves laterally with the nut 142 in the manner D₂. With this in mind, it will be appreciated that the width of the teeth on the pinion gear 124 is specifically chosen to be greater than the width of the teeth on the gear 146 to enable the gear 146 to translate across the gear 124 while maintaining torque transfer therebetween.

The nut 142 moves in the direction D₂ until it engages the end 92 of the brake shoe 90a. Further rotation of the gear 146 from this point causes the nut 142 to move the first end 92 of the brake shoe 90a into engagement with the inner surface 76 of the brake drum 74 and apply a braking force F_{A} thereto. That said, the ball screw assembly 140 lengthens during the braking event in order to apply the braking forces F_{A}, F_{B}.

The braking forces F_{A}, F_{B} are maintained on the brake drum 74 until the service braking event ends, such as when the force applied on brake pedal 42 is reduced. The force reduction on brake pedal 42 is recognized by the control system 44 which commands the motor 120 to rotate in the opposite direction such that the forces F_{A}, F_{B} applied to the brake shoes 90a, 90b are reduced. In particular, to reduce force on brake shoes 90a, 90b the motor 120 rotates the motor pinion 124 in a direction opposite to the direction R₁. This causes the gear 146 and, thus, the nut 142 to rotate in a direction opposite to the direction R₂. This, in turn, causes the spindle 156 to be retracted into the nut 142, thereby shortening the distance between the ends of the brake shoes 90a, 90b. The tension spring 98 ensures that the brake shoes 90a, 90b are in continuous contact with the ball screw assembly 140 as it retracts according to the control signal received by the motor 120 from the control system 44. Fully releasing the forces F_{A}, F_{B} on the brake drum 74 means that the brake shoes 90a, 90b are retracted such that some target clearance to the drum inner surface 76 is achieved.

With this in mind, it will be appreciated that the friction material(s) 94 can become worn over time. When this occurs, a target clearance between the brake shoes 90a, 90b and drum inner surface 76 must be maintained. Consequently, the overall length of the ball screw assembly 140 needs to increase over time for subsequent braking events. With this in mind, the spindle 150 and nut 142 can advantageously move away from one another up to a distance approximating the length of the threaded connection 156 therebetween to extend the ball screw assembly 140 and accommodate wear on the brake shoc(s) 90a, 90b.

This extension is subject to the length and position of the opening 118 in the guide 110. In other words, the threaded connection 156 in combination with the opening 118 allows the control system 44 to continue actuating the motor 120—and therefore continue lengthening the ball screw assembly 140—until the braking forces F_{A}, F_{B} are obtained regardless of the condition of the brake shoes 90a, 90b. The ball screw assembly 140 is therefore configured to automatically lengthen during cach braking event in response to wear on the brake shoes 90a, 90b.

During cach braking event, the control system 44 receives signals from the sensors 60, 62 and monitors the same during the braking event. In this manner, the control system 44 can calculate and monitor the forces F_{A}, F_{B} acting on the brake shoes 90a, 90b and make adjustments to the motor 120 torque and length of the ball screw assembly 140 in response thereto. The sensors 60, 62 can also allow the control system 44 to monitor the axial position of the spindle 150 before, during, and after braking events. The control system 44 tracks the position of the motor 120 [and therefore the length of the ball screw assembly 140] such that the target clearance between the brake shoes 90a, 90b and the drum inner surface 76 is known and tracked. When the ball screw assembly 140 achieves the target clearance level, the control system 44 commands the motor 120 to stop and at the same time (or immediately thereafter) commands the bi-stable locking mechanism 180 to engage the motor pinion 124 to maintain the target clearance. Electrical power to the motor 120 and to the locking mechanism 180 is then turned OFF.

When it is desirable to apply the parking brake (FIG. 6), the actuator 100 is actuated until the control system 44 estimates that the target braking force is achieved, at which point the motor is held powered but stationary. Then the control system 44 directs electrical power of polarity A to the locking mechanism 180. This causes the pin 182 to translate into engagement with the pinion gear 124 and thereby prevent rotation thereof. The control system 44 reduces the torque demand from the motor 120 until the current draw on the motor 120 suddenly drops to zero, confirming that the motor pinion 124 is locked. This advantageously allows the braking forces F_{A}, F_{B} to be maintained without relying on the motor torque. Power to the locking mechanism 180 is removed to automatically lock the pin 182 in engagement with the pinion gear 124.

The brake drum 74, in turn, exerts reaction forces on the brake shoes 90a, 90b. The reaction forces are transferred from the friction pads 94, to the ends 92 of the brake shoes 90a, 90b, and ultimately to the ball screw assembly 140. Consequently, the locked nut 142 and spindle 150 oppose the reaction forces applied by the brake drum 74 to the brake shoes 90a, 90b. These reaction forces, in turn, and transferred to the pinion gear 124, which is locked by the locking mechanism 180.

To release the parking brake, the control system 44 commands the motor 120 to rotate in the direction R₁ until the motor supports the full torque generated by the forces F_{A}, F_{B} on the brake shoes 90a, 90b. The motor 120 is then held powered and stationary while the control system 44 directs electrical power of polarity B to the locking mechanism 180 to cause the pin 182 to retract out of engagement with the pinion gear 124. The control system 44 then ceases power supply to the locking mechanism 180 while reducing torque to the motor 120, which will cause the motor to rotate in a direction opposite the direction R₁ (counterclockwise as shown). This counter rotation causes the actuator 100 to retract until the target clearance between brake shoes 90a, 90b and drum inner surface 76 is achieved. More specifically, the spindle 150 is retracted into the nut 142 as the nut rotates to shorten the ball screw assembly 140. This removes the forces F_{A}, F_{B} on the brake shoes 90a, 90b while the tension spring 98 maintains contact between the brake shoes 90a, 90b and ball screw assembly 140 at all times.

A situation may arise in which electrical power is no longer provided to the motor 120 for a foreseen or unforeseen reason while braking forces F_{A}, F_{B} are still present. When this occurs at a point in which the bi-stable locking mechanism 180 is disengaged, the ball screw assembly 140 is not self-locking, and therefore this loss of electrical power would cause the spindle 150 to retract fully or partially into the nut 142 under the influence of the tension spring 98 and braking forces F_{A}, F_{B} until the braking forces are fully eliminated or minimized. If the brake shoes 90a, 90b become worn, the final, uncontrolled and retracted ball screw assembly 140 may cause the brake shoes 90a, 90b to be spaced further from the drum inner surface 76 than the target clearance.

To help alleviate this concern and reduce the timeframe needed to apply service braking, the control system 44 coordinates operation of the bi-stable locking mechanism 180 with the ball screw assembly 140 to adjust the spreader 100 to accommodate wear on the brake shoes 90a, 90b while the target clearance between the brake shoes 90a, 90b and the drum inner surface 76. More specifically, the control system 44 adjusts the length of the ball screw assembly 140 by the control of the motor 120 on brake release and then locking the pinion gear 124 such that the target clearance between brake shoes 90a, 90b and drum inner surface 76 is maintained constant throughout the wear of brake shoes 90a, 90b. The target clearance should be maintained constant so that the brake apply time of the eDrum 39 remains consistent regardless of the degree of wear on the brake shoes 90a, 90b.

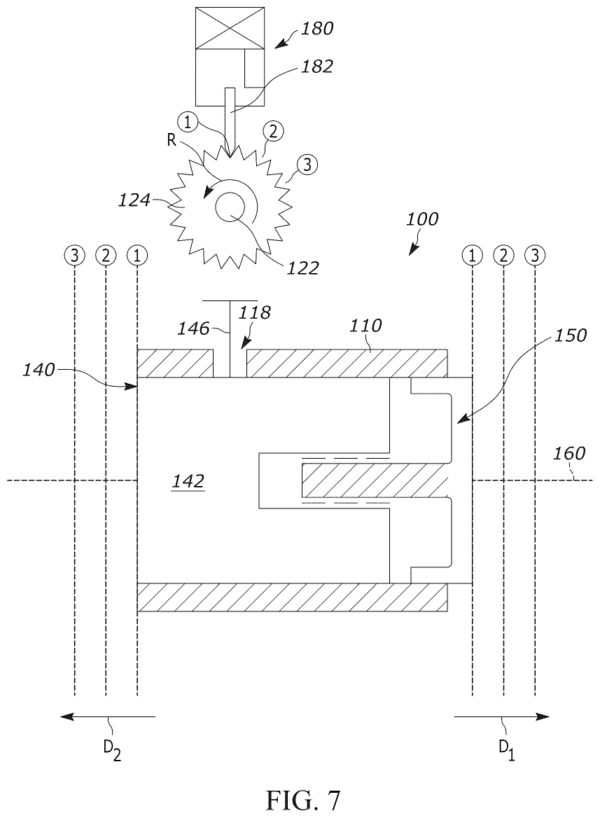

To this end, and referring to FIG. 7, the control system 44 can rely on signals from the current sensor 60 and the motor position sensor 62 and coordinate activation of the locking mechanism 180 and motor 120 such that the pin 182 engages the pinion gear 124 when the target clearance is achieved. This, in turn, causes the spindle 150 and the nut 142 to stop at corresponding axial positions relative to the axis 160 depending on the level of brake shoes 90a, 90b wear. This is illustrated schematically at \textcircled{1}\textcircled{2}\textcircled{3}, in which locking the pinion gear 124 at position \textcircled{1} thereby positions the outermost end of the nut 142 and the spindle 150 at corresponding position \textcircled{1}. The same is true for position \textcircled{2}, position \textcircled{3}, etc.

The control system 44 can therefore precisely time operation the locking mechanism 180 such that the ball screw assembly 140 has a specific initial length for each braking event that increases over time as the brake shoes 90a, 90b become more worn. Due to this configuration, the ball screw assembly 140 can have a new starting condition from which subsequent braking events begin. The new, evolving starting condition can coincide with adjusting the length of the ball screw assembly 140 to maintain a predetermined gap between the drum inner surface 76 and the ends 92 of the brake shoes 90a, 90b before the start of each successive braking event.

Maintaining a constant predetermined gap ensures that the stroke of the ball screw assembly 140 needed to apply the same braking force F_{A}, F_{B} is substantially constant over time. The control system 44 can therefore adjust the blocking position of the pinion gear 24 to shorten the aforementioned gap (by lengthening the ball screw assembly 140) when wear would otherwise cause the gap to exceed the predetermined amount. Consequently, the control system 44 ensures the same force F_{A}, F_{B} is applied to the brake shoes 90a, 90b in substantially the same time period from braking initiation to achieving the brake event.

It will be appreciated that the diameter and/or number of teeth on the pinion gear 124 can increase the precision of the rotational position at which the pinion gear is blocked from rotating. In this manner, the starting length of the ball screw assembly 140 and, thus, the initial gap between it and the brake shoes 90a, 90b can be more precisely controlled. With this in mind, when the next service brake application is requested, the control system 44 will synchronize release of the locking mechanism 180 with rotation of the motor 120 in the brake apply direction R₁.

It will be appreciated that the present invention has been shown and described as operating with the brake shoe 90b engaging the brake drum 74 first, followed by the brake shoe 90a. The order of engagement between the brake shoes 90a, 90b and the brake drum 74, however, can be reversed. In other words, the nut 142 can move the brake shoe 90a to apply the braking force F_{A}, followed by the spindle 150 moving the brake shoe 90b to apply the braking force F_{B}. In either case, the opening 118 in the guide 110 accommodates lateral movement of the gear 146 in either direction and the guide helps maintain positioning of the ball screw assembly 140 relative to the ends 92.

It will also be appreciated that although a single ball screw assembly 140 is shown the guide 110 could instead accommodate a pair of ball screw assemblies driven directly or indirectly by the pinion gear 124 (not shown). In this construction, a gear 146 is provided on cach nut 162 and extends through a respective opening 118 in the guide 110 to allow each nut to translate relative to the pinion gear(s) 124 engaged therewith during application/release of the service brake. In this dual ball screw assembly configuration, the bi-stable locking mechanism 180 would operate in the same manner to lock the single pinion gear 124, thereby simultaneously locking both pinion gears 146 for both applying the parking brake and changing the starting length of the combined ball screw assemblies (not shown).

The present invention is advantageous in that enables the actuator to operate entirely electromechanically (including both service and parking brake operation). The bi-stable locking mechanism advantageously helps to provide secure locking and release of the parking brake while the guide accommodates the reaction forces borne by the ball screw assembly during application of the service brake.

The present invention is also advantageous in that it provides precise adjustment of the starting position/length of the ball screw assembly before each braking event. In this manner, the control system can help maintain a consistent braking force in a repeatable timeframe over a consistent stroke length even as the brake shoe(s) wear over time.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for a brake drum of a vehicle having a drum brake assembly with first and second brake shoes, comprising:
a motor having a pinion gear;
a ball screw assembly having a nut for receiving torque from the pinion gear and a spindle threaded with the nut, the nut being aligned with the first brake shoe and the spindle being aligned with the second brake shoe, the motor being actuatable for rotating the nut to move the nut and the spindle away from one another for moving the brake shoes to apply braking force to the brake drum during a braking event; and
a bi-stable locking mechanism for selectively locking the motor to prevent torque transfer from a back-driving ball screw assembly to the motor.

2. The apparatus recited in claim 1, wherein the bi-stable locking mechanism selectively locks the pinion gear to adjust a starting length of the ball screw assembly prior to each braking event to account for wear on the brake shoes.

3. The apparatus recited in claim 2, wherein the bi-stable locking mechanism directly engages the pinion gear to lock the pinion gear.

4. The apparatus recited in claim 1, wherein the bi-stable locking mechanism fixes a length of the ball screw assembly to apply a parking brake to the vehicle.

5. The apparatus recited in claim 1, further comprising a control system for tracking a rotational position of the motor and thereby tracking the length of the ball screw assembly, the control system activating the bi-stable locking mechanism to adjust the starting length of the ball screw assembly to maintain a target clearance between the brake shoes and the brake drum prior to each braking event.

6. The apparatus recited in claim 1, further comprising a guide fixed to the vehicle and receiving the ball screw assembly, the nut including a gear extending through an opening in the guide for connecting to the pinion gear.

7. The apparatus recited in claim 6, wherein the opening allows the gear to move longitudinally relative to the pinion gear to accommodate relative movement between the nut and the spindle.

8. The apparatus recited in claim 1, wherein the bi-stable locking mechanism is electromagnetic.

9. The apparatus recited in claim 1, wherein the bi-stable locking mechanism locks the pinion gear during the braking event to apply a parking brake.

10. The apparatus recited in claim 1, wherein the spindle is not self-locking with the nut.

11. The apparatus recited in claim 1, wherein the bi-stable locking mechanism has a first condition engaging and locking the pinion gear in response to receiving electrical power of a first polarity and has a second condition retracted from the pinion gear for allowing rotation of the pinion gear in response to receiving electrical power of a second polarity.

12. The apparatus recited in claim 10, wherein the bi-stable locking mechanism includes a pin that moves axially relative to pinion gear between the first condition and the second condition.

13. The apparatus recited in claim 1, further comprising a return spring configured to be connected to both brake shoes for biasing the brake shoes towards one another, the bi-stable locking mechanism being activated to limit retraction of the brake shoes by return spring.

14. The apparatus recited in claim 1, wherein at least one gear stage is provided between the pinion gear and the ball screw nut for transferring torque therebetween.

15. A method of operating a drum brake assembly for a brake drum of a vehicle having first and second brake shoes, comprising:
positioning a ball screw assembly having a starting length between the first and second brake shoes for moving the first and second brake shoes to apply braking force to the brake drum during a braking event;
coupling a motor to the ball screw assembly for adjusting the length thereof; and
activating a bi-stable locking mechanism for preventing rotation of the motor to thereby prevent back-drive of the ball screw assembly to adjust the starting length of the ball screw assembly prior to each braking event to account for wear on the brake shoes.

16. The method recited in claim 15 further comprising selecting the starting length to maintain a target clearance between the brake shoes and the brake drum prior to each braking event.

17. The method recited in claim 15, wherein the bi-stable locking mechanism blocks the motor at a first rotational position to define a first starting length of the ball screw assembly and thereafter blocks the motor at a second rotational position to define a second starting length of the ball screw assembly greater than the first starting length to account for wear on the brake shoes.

18. The method recited in claim 15, wherein the bi-stable locking mechanism has a first condition engaging and locking an pinion gear of the motor in response to receiving electrical power of a first polarity and having a second condition retracted from the pinion gear for allowing rotation thereof in response to receiving electrical power of a second polarity.

19. The method recited in claim 18, wherein the bi-stable locking mechanism includes a pin that moves axially relative to the pinion gear between the first condition and the second condition.

20. The method recited in claim 18 further comprising activating the bi-stable locking mechanism to lock the pinion gear during the braking event to apply a parking brake.

21. The method recited in claim 15 further comprising:
monitoring a current draw on the motor during a first braking event; and
increasing the starting length of the ball screw assembly prior to a second braking event in response to the monitored current draw.

22. The method recited in claim 15, wherein the spindle is not self-locking with the nut.
